(19) United States
(12) Patent Application Publication
(10) Pub. No.: US 2026/0357481 A1
(43) Pub. Date: Nov. 12, 2026

(54) A Method Of Recovering Polyurethane Polymer From A Waste Polymer Textile Material That Comprises Polyester And Polyurethane Fibers

(71) Applicant: loniqa Solutions B.V., Eindhoven (NL)

(72) Inventors: Fabian WOUTERS, Eindhoven (NL); Jannigje Maria Jacomina GRAVENDEEL, Eindhoven (NL)

(73) Assignee: loniqa Solutions B.V., Eindhoven (NL)

(21) Appl. No.: 19/491,180

(22) PCT Filed: Jun. 4, 2024
(86) PCT No.: PCT/NL2024/050283

§ 371 Date: Dec. 8, 2025

(30) Foreign Application Priority Data
Jun. 9, 2023 (NL) 2035060

(51) Int. Cl. D01G 11/00; C08G 63/183; C08J 11/24; C08J 11/28

(52) U.S. Cl. CPC D01G 11/00; C08G 63/183; C08J 11/24; C08J 11/28; D10B 2321/08; D10B 2331/02; D10B 2331/10

(57) ABSTRACT

A method of recovering polyurethane polymer from a waste polymer textile material that comprises polyester and polyurethane fibers is described. The method comprises providing the waste polymer textile material in shredded or cut form; contacting the waste polymer textile material in shredded or cut form with a polar aprotic solvent at a temperature from 25 to 125 °C to dissolve the polyurethane at least partly in the polar aprotic solvent while the polyester remains substantially unaffected; separating the polyester from the solvent mixture comprising the polar aprotic solvent and the polyurethane dissolved therein by solid-liquid separation; precipitating the dissolved polyurethane in the solvent mixture; separating the precipitated polyurethane from the solvent mixture to obtain polyurethane polymer and used polar aprotic solvent; and optionally reusing the used polar aprotic solvent.

### FIELD OF THE INVENTION

The present invention is in the field of obtaining useful products from a waste polymer textile material. It relates to a method of recovering polyurethane polymer from a waste polymer textile material that comprises polyester and polyurethane fibers. The invented method is environmentally friendly in the sense that, in addition to the waste polymer textile material, any solvents used in the method may be recycled.

### BACKGROUND OF THE INVENTION

Polymer textile materials are widely used today in various articles, such as in carpets, apparel, covering, bedding, and the like. Reuse and disposal of post-consumer textile articles is complicated by the fact that waste polymer textile materials are increasingly composed of a mixture of polymers that each contribute to a particular desired property. For instance, polyurethane polymer fiber, such as Elastane or Lycra, is increasingly used in articles such as jeans and sportswear to impart elasticity. In such cases, the polyester fiber may then impart other desirable properties such as strength, durability, and breathability.

In order to be able to reuse the raw materials from which the waste polymer textile material is made, requires an effective separation of the various components and a proper separation method is therefore needed.

Although attempts have been made to separate the fibers mechanically, more recent methods aim at separating the components by chemical methods. One such method, disclosed in CN 110790980A, contacts a waste polyester fiber material with an organic solvent having a boiling point of 20-230 °C at temperatures that may range from 20-180 °C. The soluble fibers other than polyester are dissolved and then filtered, and the filtrate is distilled. The organic solvent may be recovered but this requires fractional distillation, which is expensive. The dissolving temperatures vary with the type of soluble polymer that needs to be removed. Dissolving polyurethane for instance requires a temperature in the range of 130-150 °C.

The known method suffers from the fact that for each soluble polymer, a different solvent needs to be used. Polyurethane requires a polar aprotic solvent, while nylon requires formic acid, and separating polylactic acid fiber requires cyclohexanone. Each of the solvents may in some amounts remain in the polyester which seriously restricts the further use of such polyester. Also, because of the relatively high dissolving temperatures used, the dissolved polymer may not be separated efficiently from the solvent, which solvent therefore likely contains impurities. This hampers their reuse, which from an environmental point of view is undesirable.

There is a need therefore for an improved method of recovering polyurethane polymer from a waste polymer textile material that comprises polyester and polyurethane fibers, which method does not have the disadvantages of the prior art, or at least to a lesser extent. Another aim is to provide an improved separation method that is more cost effective and more robust, without generating further waste streams. Yet another aim is to provide an improved method of recovering other soluble polymers besides polyurethane polymer from a waste polymer textile material that comprises polyester and polyurethane fibers.

### SUMMARY OF THE INVENTION

The present invention provides a method as claimed in claim 1. The method of recovering polyurethane polymer from a waste polymer textile material that comprises polyester and polyurethane fibers comprises the steps of:
a) providing the waste polymer textile material in shredded or cut form;
b) contacting the waste polymer textile material in shredded or cut form with a polar aprotic solvent at a temperature from 25 to 125 °C to dissolve the polyurethane at least partly in the polar aprotic solvent while the polyester remains substantially unaffected;
c) separating the polyester from the solvent mixture comprising the polar aprotic solvent and the polyurethane dissolved therein by solid-liquid separation;
d) precipitating the dissolved polyurethane in the solvent mixture;
e) separating the precipitated polyurethane from the solvent mixture to obtain polyurethane polymer and used polar aprotic solvent;
f) reusing the used polar aprotic solvent in step b).

The polyurethane polymer turned out to be soluble in the polar aprotic solvent at the dissolving temperatures from 25 to 125 °C, and also at higher temperatures. The method not only allows to remove a polyurethane polymer from a waste polymer textile material but also to recover the polyurethane polymer as a useful polymer. The polyurethane polymer may be used as raw material directly in a subsequent process, for instance a fiber making (spinning) process. The inventors have found that the relatively low dissolving temperature of from 25 to 125 °C allows maintaining a relatively high molecular weight of the soluble polymer, in particular the polyurethane polymer. This makes it directly suitable for a follow-up process in which the polymer is turned into a useful article, but, at the same time, has proven to yield a much more efficient extraction of the polymer from the polar aprotic solvent. This allows reusing the polar aprotic solvent directly in the method and prevents or limits disposal and/or subsequent distillation of the solvent.

### DETAILED DESCRIPTION OF THE INVENTION

The waste polymer textile material may be supplied in a suitable form in which it is provided in relatively small pieces, such as in shredded or cut form. Shredding involves chopping the waste polymer textile material in a shredder. This may produce pieces of some length, such as strips or ribbons. The waste polymer material may also be cut in smaller pieces with typical linear dimensions of 0.1 to 10 cm. Such loose cut pieces of waste polymer textile material have a typical density of 10-50 g/dm³, such as about 20 gr/dm³. The density of the waste textile material may be reduced, such as by fluffing. Fluffed textile material may for instance be obtained by fiberizing the material in which process the textile material is needled and torn apart. In this form, the waste textile material comprises relatively small bits of loose fibrous material and a relatively high amount of air in between the fibrous bits. The density of textiles in loose fiber form would be around 5-10 gr/dm³. In the industry, waste polymer textile material after sorting is typically provided in big bags, in which the textile material is compressed to bulk densities between about 170 and 310 gr/dm³, or even up to 500 gr/dm³. The invented method allows handling waste polymer textile material having the densities mentioned above. Therefore, suitable densities are in the range of 5-500 gr/dm³, preferably 80-400 gr/dm³, more preferably 100-380 gr/dm³, and most preferably 120-350 gr/dm³.

In another embodiment, the density of the waste polymer textile material is from 5-500 gr/dm³, such as from 100-500 g/dm³, such as from 150-500 g/dm³, such as from 200-500 gr/dm³, such as from 250-500 gr/dm³. Another embodiment provides densities of the waste polymer textile material from 5-450 gr/dm³, such as from 5-400 gr/dm³, such as from 5-350 g/dm³, such as from 5-300 gr/dm³.

It may be advantageous to provide the waste polymer textile material in cut form, which is preferred. This embodiment may improve separating the different fibers in the waste polymer textile material.

The waste textile material comprises polyester and polyurethane fibers. Polyurethane comprises organic units that are joined by carbamate links and may be formed by reacting a polyisocyanate with a polyol. Terephthalate polymers are a group of polyesters comprising terephthalate in the backbone. The most common example of a terephthalate polymer is polyethylene terephthalate, also known as PET. Alternative examples include polybutylene terephthalate, polypropylene terephthalate, polypentaerythrityl terephthalate and copolymers thereof, such as copolymers of ethylene terephthalate and polyglycols, for instance polyoxyethylene glycol and poly(tetramethylene glycol) copolymers. PET is one of the most common polymers and it is highly desired to recycle PET by depolymerization thereof into reusable raw material.

The waste polymer textile material in shredded or cut form is contacted with a polar aprotic solvent, for instance by adding the polar aprotic solvent to the waste polymer textile material. In the context of the present application, the wording ‘polar’ also encompasses ‘dipolar’. Solvents are generally classified by their polarity, and considered either polar or non-polar, as indicated by their dielectric constant. In the context of the present application, solvents with a dielectric constant greater than about 5 are considered polar. The solvent is also aprotic. Aprotic solvents lack an acidic proton by lacking hydroxyl and amine groups. Aprotic solvents therefore do not serve as proton donors in hydrogen bonding but they can be proton acceptors. Suitable polar aprotic solvents comprise but are not limited to dichloromethane (DCM), tetrahydrofuran (THF), ethyl acetate, acetonitrile, dimethylformamide (DMF), dimethylpropyleneurea, dimethyl acetamide (DMAc), dimethyl sulfoxide (DMSO), acetone, hexamethylphosphoric triamide (HMPT), N-methylpyrrolidon (NMP), pyridine, and sulfolane. Preferred polar aprotic solvents have a dielectric constant above 10, more preferably above 20 and most preferably above 30. DCM and THF are less preferred, and DMF in particular is less preferred. Biosolvents may also be used, such as dihydrolevoglucosenone (Cyrene), a levulinate alkyl ester, such as methyl levulinate, ethyl levulinate, or propyl levulinate, gamma-valerolactone, a lactate alkyl ester, such as methyl lactate, ethyl lactate, and propyl lactate, furfural, furfuryl alcohol, levulinic acid, or mixtures thereof.

Heating the mixture to a temperature within the range from 25 to 125 °C is carried out until the polyurethane polymer is dissolved. The temperature is preferably from 40 to 110 °C, more preferably from 60 to 100 °C, and most preferably from 70 to 90 °C, in view of recovery of the polyurethane polymer from the mixture. The heating is typically performed for a period of 15 min to 8 h, more preferably from 1 to 7 h, and most preferably from 2 to 6 h. The pressure is typically from 90-200 kPa, such as atmospheric. The heating step results in the formation of a slurry comprising the polyester and dissolved polyurethane. While the polyurethane is at least partially dissolved at the selected dissolving temperature and duration, the polyester does not dissolve and remains substantially unaffected. It is preferred that the heating is carried out such that substantially all polyurethane is dissolved. However, this is not deemed necessary. Minor amounts, for instance up to 10%, such as up to 5%, preferably up to 3% or even up to 1% by weight relative to the initial amount of polyurethane may remain undissolved.

The above method step b) of dissolving the polyurethane in the polar aprotic solvent may be performed by adding a suitable catalyst. However, preferably, a catalyst is not added in step b). After the dissolution step, the slurry is subjected to a solid-liquid separation in which the polyester is separated from the solvent mixture which comprises the polar aprotic solvent and the dissolved polyurethane. Any suitable solid-liquid separation method may be used, such as centrifugation or filtering, or combinations of these. Typically, a step of filtering is performed over a crude filter thereby forming a filtrate. Herewith the polyester is separated from the solvent mixture by having the polyester remain on the filter, whereas the solvent mixture goes through the filter as a liquid and possibly in the form of small particles. The mesh size of the filter is preferably not too small in order to allow passage of the liquid, and not too large in order to retain the polyester.

After collecting the filtrate that contains the solvent mixture, the polyurethane present in the solvent mixture is precipitated and separated from the solvent mixture. The polyurethane can then be processed further or re-used. Preferably, the mesh is smaller than 10 μm, more preferably between 5 and 9 μm. In addition to the mesh size, the used pressure may also play a role, whereby a larger underpressure typically allows for smaller mesh sizes. This embodiment is suitably carried out by providing the solvent mixture or slurry in a filtration chamber including the filter, wherein an underpressure is applied over the filter.

A useful embodiment provides a method wherein precipitating the dissolved polyurethane in the solvent mixture in step d) comprises adding water to the solvent mixture, which solvent mixture is optionally cooled to a temperature below the contacting temperature of step b) before, during or after adding the water. It is not excluded that the hot water is added as an aqueous solution, or as a mixture of alcohol and water.

In a further improved embodiment, the water (or aqueous solution) added has a temperature at ambient pressure from 1-100 °C, more preferably from 5-50 °C, even more preferably from 10-40 °C, and most preferably a temperature at ambient pressure from 15-30 °C. It has turned out that adding relatively cold water to the solvent mixture significantly improves the precipitation and the subsequent separation of the precipitated polyurethane, in particular in combination with a relatively low dissolving temperature within the range of 60 to 100 °C, and more preferably from 70 to 90 °C.

An advantage of the claimed method resides in that the recovered polyurethane has a relatively high molecular weight. This allows its re-use without further treatment. In an embodiment of the method as claimed, the polyurethane polymer obtained in step e) has a number average molecular weight Mn of at least 50000 Da, more preferably of at least 65000 Da, and most preferably of at least 90000 Da. Alternatively, the polyurethane polymer obtained in step e) has a weight average molecular weight Mw of at least 100000 Da, more preferably of at least 130000 Da, and most preferably of at least 180000 Da. The Mn and Mw were determined by gel permeation chromatography at 40 °C using DMF and 0.02 m lithium bromide as eluent. The samples may show a bimodal distribution with a secondary peak at lower molecular weights. In all cases, Mn and Mw were defined for the main (primary) peak in the molecular weight distribution.

In order to improve the reusability of the used polar aprotic solvent, an embodiment of the method is provided wherein the added water is separated from the used polar aprotic solvent obtained in step e) before reusing the polar aprotic solvent according to step f). Since the boiling point of the added water will generally deviate from (and in most embodiments be lower than) the boiling point of the polar aprotic solvent used in the method, this separation may be simply carried out by evaporation of the water.

The amount of polar aprotic solvent that may still remain in the polyester after step c) may be reduced further by an embodiment of the method wherein the polyester obtained in step c) is squeezed and/or washed in a suitable washing liquid, such as water or a polyalcohol. Squeezing may for instance be performed in a pressurizing device, such as in a pressure roll. The washing or rinsing may be performed in one step or may be repeated in a number of steps, for instance by providing the polyester in a washing tank.

In a further preferred method according to an embodiment thereof, the method further comprises the steps of
g) contacting the polyester obtained in step c) with an alcoholic solvent at a temperature from 50 to 200 °C to further dissolve potentially remaining polyurethane in the alcoholic solvent while the polyester remains substantially unaffected; and
h) separating the polyester from the alcoholic solvent mixture comprising the alcoholic solvent, the potentially remaining polyurethane dissolved therein and potentially remaining polar aprotic solvent, by solid-liquid separation.

The contacting with the alcoholic solvent and subsequent separation of the polyester from said solvent mixture represents a second step in this embodiment which differs and is subsequent to the first step of contacting the polyester in the polar aprotic solvent. It may be carried out in the same manner as was described above for the polar aprotic solvent of the first step.

The second step allows further decreasing the amount of polar aprotic solvent present in the polyester, as well as decreasing the amount of Elastane in the polyester. This is important since small amounts of polar aprotic solvent and/or Elastane in the polyester may lead to discoloration in further downstream processes, such as in a process wherein the polyester is depolymerized into its monomers. As will be disclosed further below, the addition of the alcoholic solvent does not pose such a problem since the alcoholic solvent is used anyway in depolymerizing the polyester by glycolysis. According to an embodiment of the method, the amount of polar aprotic solvent that is still present in the polyester after step h) relative to the amount of alcoholic solvent in the alcoholic solvent mixture is below 1:1, more preferably below 1:2, even more preferably below 1:5, and most preferably below 1:10. It has turned out that the presence of the aprotic solvent in the polyester after step h) is so low that discoloration of the polyester (and of the ensuing bis(2-hydroxyethyl) terephthalate, in short referred to as BHET, after depolymerization) is substantially prevented. Surprisingly, this may be achieved in this embodiment that involves the second step. Without wanting to be bound by any theory, it may be that the aprotic solvent in step g) of this embodiment is evaporated to such extent that it does not pose any problems of discoloration of the polyester or the optionally ensuing BHET after an optional depolymerization step.

Step g) of the preferred method is preferably carried out at a temperature from 110 °C to 190 °C, more preferably from 120 °C to 170 °C, even more preferably from 130 °C to 150 °C.

The alcoholic solvent may be selected from mono-alcohols, di-alcohols, and tri-alcohols. Preferably, use is made of non-halogenated alcohols. More preferably, use is made of a polyol. It is preferred to use smaller chain alcohols, such as C6-C10 mono-alcohols, and likewise preferably C2-C10 di-alcohols, more preferably C2-C8 di-alcohols. Examples thereof are vicinal diols, and germinal diols. Examples of suitable alcohols include 1-hexanol, 3-methyl-1-pentanol, 4-methyl-1-pentanol, 1-heptanol, 2-heptanol, 3-heptanol, 4-heptanol, 1-octanol, 2-octanol, 2-ethyl-1-hexanol, 4-methyl-3-heptanol, 5-methyl-3-heptanol, 2,2,3-trimethyl-3-pentanol, 1-nonanol, 2-nonanol, 3-nonanol, 4-nonanol, 5-nonanol, 7-methyl-1-octanol, 2,6-dimethyl-4-heptanol, 3,5-dimethyl-4-heptanol, 3,5,5-trimethyl-1-hexanol, 1-decanol, and 1,4-benzenedimethanol, ethylene glycol (1,2-ethanediol) and diethylene glycol, 1,3-propanediol, 1,4-butanediol, 1,5-pentanediol, 1,2-pentanediol, hexane-1,2-diol, hexane-1,6-diol, heptane-1,2-diol, heptane-1,7-diol, octane-1,2-diol, octane-1,8-diol, nonane-1,3-diol, nonane-1,9-diol, decane-1,2-diol, decane-1,10-diol, undecane-1,2-diol, undecane-1,11-diol, dodecane-1,2-diol, and dodecane-1,12-diol. Preferred alcohols to be used in the second step in the appropriate embodiments comprise a glycol, more preferably an alkylene glycol, selected from ethylene glycol (1,2-ethane diol), propylene glycol (1,3-propane diol), 1,4-butane diol and 1,5-pentane diol.

A further advantage of the two-step embodiment resides in that it may be used to remove other polymers than the polyurethane, that are present in the waste polymer textile material. In an embodiment, the waste polymer textile material further comprises polyamide fibers, the polyamide is dissolved in step g) and then separated from the polyester in step h). Separation is preferably carried out as disclosed above for the separation of polyurethane.

Polyamides comprise macromolecules with repeating units linked by amide bonds (such as O═C—NH—C). Artificial polyamides relate to materials such as nylons, aramids, and sodium poly(aspartate). Polyamides may relate to aliphatic polyamides, such as PA6 and PA 66, polyphtalamides, such as PA 6T, and aramids. Synthetic polyamides are commonly used in textiles, automotive applications, carpets, and sportswear due to their high durability and strength.

Yet another embodiment relates to a method wherein the waste polymer textile material further comprises acrylic polymer fibers, the acrylic polymer is dissolved in step b), and the dissolved acrylic polymer is separated from the first mixture in step d). Removal of acrylic polymers such as polyacrylonitrile surprisingly can be carried out in the one-step embodiment using the same polar aprotic solvent as used for polyurethane removal. Another advantage of using this polar aprotic solvent is that the acrylic polymers may be dissolved therein at relatively low temperatures, such as from 25 to 80 °C, more preferably from 30 to 65 °C, and most preferably from 40 to 50 °C. The dissolved acrylic polymer remains dissolved in the solvent mixture after separating the polyester from the solvent mixture and is not precipitating therein. It may be removed from the polar aprotic solvent by fractional distillation for instance.

In another embodiment of the method the waste polymer textile material further contains functional additives such as dyes, and the functional additives are dissolved in the polar aprotic solvent and separated from the polyester in step d) with the polar aprotic solvent.

A preferred polar aprotic solvent comprises dimethylacetamide (DMAc), which is shown to increase the separation efficiency of the polyurethane when compared to the use of another polar aprotic solvent, such as dimethylformamide (DMF).

The weight ratio of the polar aprotic solvent relative to the textile waste material may be varied between wide ranges but is preferably above 1:1. In a preferred embodiment, the weight ratio of textile waste material to polar aprotic solvent ranges from 1:2 to 1:40, more preferably from 1:5 to 1:35, more preferably from 1:10 to 1:25, and most preferably from 1:15 to 1:20. The lower ratios use less solvent and are more preferred.

A preferred embodiment provides a method wherein the polyester comprises polyethylene terephthalate, and/or the polyurethane comprises a polyether-polyurea copolymer, such as Elastane for instance.

In another embodiment, the acrylic polymer that may be present in the waste polymer textile material comprises polyacrylonitrile fibers. Polyacrylonitrile polymers refer to both homopolymers of acrylonitrile and copolymers of acrylonitrile with one or two or more copolymerizable monomers. Such copolymers preferably contain at least 70%, preferably above 85% by weight of acrylonitrile and at most 30%, preferably below 15% by weight of the copolymerizable monomer. The copolymerizable monomers may include addition polymerizable monomers containing an ethylenically double bond, such as methyl acrylate, methyl methacrylate, ethyl acrylate, chloroacrylic acid, ethyl methacrylate, acrylic acid, methacrylic acid, acrylamide, methacrylamide, butyl acrylate, methacrylonitrile, butyl methacrylate, vinyl acetate, vinyl chloride, vinyl bromide, vinyl fluoride, vinylidene chloride, vinylidene bromide, allyl chloride, methyl vinyl ketone, vinyl formate, vinyl chloroacetate, vinyl propionate, styrene, vinyl stearate, vinyl benzoate, vinyl pyrrolidone, vinyl piperidine, 4-vinyl pyridine, 2-vinyl pyridine, N-vinyl phthalimide, N-vinyl succinimide, methyl malonate, N-vinyl carbazol, methyl vinyl ether, itaconic acid, vinylsulfonic acid, styrenesulfonic acid, allylsulfonic acid, methallylsulfonic acid, vinyl furan, 2-methyl-5-vinyl pyridine, binaphthalene, itaconic ester, chlorostyrene, vinylsulfonate salt, styrenesulfonate salt, allylsulfonate salt, methallylsulfonate salt, vinylidene fluoride, 1-chloro-2-bromoethylene, .alpha.-methylstyrene, ethylene and propylene, and the like.

The waste polymer textile material may comprise several polymer materials. In a preferred embodiment, a method is provided wherein the waste polymer material comprises from 85-99 wt. % polyester, from 1-15 wt. % polyurethane, and optionally polyamide and/or acrylic polymer, the total adding up to 100 wt. %. The amount of polyamide in the waste polymer textile material may be up to 15 wt. %, more preferably up to 10 wt. %, and most preferably up to 5 wt. %. The amount of acrylic polymer in the waste polymer textile material may be up to 15 wt. %, more preferably up to 10 wt. %, even more preferably up to 5 wt. %, and most preferably up to 2 wt. %. It should be noted that the presence of polyamide and acrylic polymer fiber in the waste polymer textile material is only optional, and not essential to the invention.

In another aspect of the invention, a method is provided that further comprises the steps of
i) adding a reactive solvent to disperse the polyester recovered after step h) and obtain a dispersion;
j) adding a depolymerization catalyst to the dispersion;
k) depolymerizing the polyester under conditions to obtain monomers and/or oligomers dissolved in the reactive solvent;
wherein the reactive solvent comprises an alcoholic solvent, optionally the alcoholic solvent obtained from step h).

One preferred way of depolymerization is glycolysis, which is preferably catalyzed. Typically, as a result of the preferred use of ethylene glycol, a reaction mixture comprising at least one monomer comprising bis(2-hydroxyethyl) terephthalate (BHET) may be formed. One example of a suitable depolymerization by glycolysis is known from WO2016/105200 in the name of the present applicant. According to this process, the terephthalate polymer is depolymerized by glycolysis in the presence of a specially designed catalyst. At the end of the depolymerization process, water is added, and a phase separation occurs. This enables to separate a first phase comprising the BHET monomer from a second phase comprising catalyst, oligomers, and additives. The first phase may comprise impurities in dissolved form and as dispersed particles. The BHET monomer can be obtained by means of crystallization.

A high purity is required for reuse of the depolymerized raw material. As is well-known, any contaminant may have an impact on the subsequent polymerization reaction from the raw materials. Moreover, since terephthalate polymers are used for food and also medical applications, strict rules apply so as to prevent health issues. The present invention allows achieving such a high purity.

The depolymerization step involves glycolysis, in which the ethylene glycol solvent is also a reactant to obtain BHET, and eventually the other by-products, rather than for instance terephthalic acid that would be generated in hydrolysis. A polymer concentration in the reaction mixture or dispersion is typically from 1-30 wt. % of the total weight of the reaction mixture, although concentrations outside this range may also be possible.

The amount of ethylene glycol (EG) in the reaction mixture may be chosen within wide ranges. In a useful embodiment, the weight ratio of EG to the polymer is in the range of from 20:10 to 100:10, more preferably from 40:10 to 90:10, and most preferably from 60:10 to 80:10.

The reaction mixture may be heated in step k) to a suitable temperature which is preferably maintained during depolymerization. The depolymerization may be carried out at a temperature of at least 160 °C, preferably of at least 180 °C, more preferably of at least 190 °C. The temperature may conveniently be selected in the range of from 160 °C to 250 °C. More preferably, the depolymerization step may comprise forming the monomer at a temperature in the range of from 185 °C to 225 °C. Suitable pressures in a depolymerization reactor are from 1-5 bar, wherein a pressure higher than 1.0 bar is preferred, and more preferably lower than 3.0 bar.

An average residence time of the BHET monomer during the depolymerization step may range from 30 sec-3 hours, and longer. In order to stop the depolymerization reaction and/or deactivate the catalyst, the temperature may be reduced to a temperature below 160 °C or lower, but preferably not lower than 85 °C.

The invention may be carried out using any catalyst suitable for the purpose. Suitable catalysts include heterogeneous catalysts. In a depolymerization method according to an embodiment, the catalyst then forms a dispersion in the reaction mixture during step c). Other suitable catalysts include homogeneous catalysts. These do not form a dispersion but are typically dissolved in the reaction mixture during step c).

Several of the possible heterogeneous depolymerization catalysts are based on ferromagnetic and/or ferrimagnetic materials. Also, anti-ferromagnetic materials, synthetic magnetic materials, paramagnetic materials, superparamagnetic materials, such as materials comprising at least one of Fe, Co, Ni, Gd, Dy, Mn, Nd, Sm, and preferably at least one of O, B, C, N, such as iron oxide, such as ferrite, such as magnetite, hematite, and maghemite can be used. The catalyst particles may comprise nanoparticles.

The catalyst particles catalyze the depolymerization reaction. In this depolymerization reaction individual molecules of the condensation polymer are released via a catalytic reaction out of the solid polymer, which polymer is for instance semi-crystalline. This release results in dispersing of polymer material into the reactive solvent and/or dissolving of individual polymer molecules in the reactive solvent. Such dispersing and/or dissolving is believed to further enhance depolymerization from polymer into monomers and oligomers.

One class of suitable catalysts includes the transition metals, in their metallic or ionic form. The ionic form includes free ions in solutions and in ionic bonds or covalent bonds. Ionic bonds form when one atom gives up one or more electrons to another atom. Covalent bonds form with interatomic linkage that results from the sharing of an electron pair between two atoms. The transition metal may be chosen from the first series of transition metals, also known as the 3d orbital transition metals. More particularly, the transition metal is chosen from iron, nickel and cobalt. Since cobalt however is not healthy and iron and nickel particles may be formed in pure form, iron and nickel particles are most preferred. Furthermore, use can be made of alloys of the individual transition metals.

If a catalytic particle is made of metal, it may be provided with an oxide surface, which may further enhance catalysis. The oxide surface may be formed by itself, in contact with air, in contact with water, or the oxide surface may be applied deliberately.

Most preferred is the use of iron containing particles. Besides that iron containing particles are magnetic, they have been found to catalyze the depolymerization of PET for instance to conversion rates into monomer of 70-90% within an acceptable reaction time of at most 6 hours, however depending on catalyst loading and other processing factors such as the PET/solvent ratio.

Non-porous metal particles, in particular transition metal particles, may be suitably prepared by thermal decomposition of carbonyl complexes such as iron pentacarbonyl and nickel tetracarbonyl. Alternatively, iron oxides and nickel oxides may be prepared via exposure of the metals to oxygen at higher temperatures, such as 400 °C and above. A non-porous particle may be more suitable than a porous particle, since its exposure to the alcohol may be less, and therefore, the corrosion of the particle may be less as well, and the particle may be reused more often for catalysis. Furthermore, due to the limited surface area, any oxidation at the surface may result in a lower quantity of metal-ions and therewith a lower level of ions that are present in the product stream as a leached contaminant to be removed therefrom.

Another class of suitable catalysts includes particles based on earth alkali elements selected from beryllium (Be), magnesium (Mg), calcium (Ca), strontium (Sr) and barium (Ba), and their oxides. A preferred earth alkali metal oxide is magnesium oxide (MgO). Other suitable metals include but are not limited to titanium (Ti), zirconium (Zr), manganese (Mn), zinc (Zn), aluminum (Al), germanium (Ge) and antimony (Sb), as well as their oxides, and further alloys thereof. Also suitable are precious metals, such as palladium (Pd) and platinum (Pt). MgO and ZnO have been found to catalyze the depolymerization of PET for instance to conversion rates into monomer of 70-90% within an acceptable reaction time, however depending on catalyst loading and other processing factors such as the PET/solvent ratio. Suitable catalysts based on hydrotalcites are also considered.

Preferably, the catalyst particles are selected so as to be substantially insoluble in the (alcoholic) reactive solvent, also at higher temperatures of more than 100 °C. Oxides that readily tend to dissolve at higher temperatures in an alcohol such as ethylene glycol, such as for instance amorphous SiO₂, are less suited.

The preferred concentration of catalyst is 1 wt % relative to the amount of PET or less. Good results have also been achieved with a catalyst loading below 0.2 wt % and even below 0.1 wt % relative to the amount of PET. Such a low loading of the catalyst is highly beneficial, and the invented method allows recovering an increased amount of the nanoparticle catalyst.

Non-porous particles according to the invention have a surface area suitably less than 10 m²/g, more preferably at most 5 m²/g, even more preferably at most 1 m²/g. In another embodiment, the surface area is at least 3 m²/g. The porosity is suitably less than 10⁻² cm³/g or for instance at most 10⁻³ cm³/g. Porous particles may also be used, generally exhibiting a larger surface area.

In a depolymerization method according to an embodiment, the catalyst forms a dispersion in the reaction mixture during mixing and/or depolymerization. A particularly preferred heterogeneous catalyst that may be used in the invention is a catalyst complex comprising catalyst particles and a catalyst entity that is associated with the catalyst particles, for instance attached thereto via a linking group. The catalyst entity comprises an ionic liquid comprising a cationic moiety having a positive charge and an anionic moiety having a negative charge. The catalyst particles are preferably nanoparticles, and more preferably magnetic particles and the latter are preferably used in a method wherein the recovering step of said catalyst is carried out using a magnetic force of attraction between a magnet and said particles. The catalyst particles in themselves may also exhibit catalytic activity.

The catalyst complex (ABC) comprises three distinguishable elements: a (nano) particle (A), a bridging moiety comprising a linking group (B) attached to the particle chemically, such as by a covalent bond, or physically, such as by adsorption, and a catalyst entity (C) that is associated with the particles (A), such as by being chemically bonded, for instance covalently bonded, to the linking group. The linking group preferably does not fully cover the nanoparticle surface, such as in a core-shell particle.

The particles of the claimed catalyst complex are preferably based on ferromagnetic and/or ferrimagnetic materials. Also, anti-ferromagnetic materials, synthetic magnetic materials, paramagnetic materials, superparamagnetic materials, such as materials comprising at least one of Fe, Co, Ni, Gd, Dy, Mn, Nd, Sm, and preferably at least one of O, B, C, N, such as iron oxide, such as ferrite, such as hematite (Fe₂O₃), magnetite (Fe₃O₄), and maghemite (Fe₂O₃, γ-Fe₂O₃) may be used. In view of costs, even when fully or largely recovering the present catalyst complex, relatively cheap particles are preferred, such as particles comprising iron (Fe). A further advantage of particles of iron or iron oxides is that they have highest saturation magnetisation, making it easier to separate the particles via a magnetic separator. And even more importantly, the iron oxide (nano) particles have a positive impact on the degradation reaction. The iron oxide may further contain additional elements such as cobalt and/or manganese, for instance CoFe₂O₄.

The catalyst particles that are used in the catalyst complex according to the invention may be coated at least partly with a protective coating. The coating may further serve to stabilize the catalyst in that the particles remain in suspension. Thus, at least a part of the surface of the catalyst particles may be coated with materials such as polyethyleneimine (PEI), polyethylene glycol (PEG), silicon oil, fatty acids like oleic acid or stearic acid, silane, a mineral oil, an amino acid, or polyacrylic acid or, polyvinylpyrrolidone (PVP). Carbon is also possible as coating material. The coating may be removed before or during the catalytic reaction. Ways to remove the coating may for instance comprise using a solvent wash step separately before using it in the reactor, or by burning in air. Removal of the coating, however, is not essential.

Preferably, the catalyst particles are selected to be substantially insoluble in the (alcoholic) reactive solvent, also at higher temperatures of more than 100 °C. Oxides that readily tend to dissolve at higher temperatures in an alcohol such as ethylene glycol, such as for instance amorphous SiO₂, are less suited.

It has been found that the catalyst particles preferably are sufficiently small for the catalyst complex to function as a catalyst, therewith degrading the terephthalate polymer into smaller units, wherein the yield of these smaller units and specifically the monomers thereof, is high enough for commercial reasons. It has further been found that the nanoparticles preferably are sufficiently large in order to be able to reuse the present complex by recovering the present catalyst complex. Suitable catalyst particles have an average diameter of larger than 1 μm up to 3 μm and larger. Suitable nanoparticles have an average diameter of 2-500 nm, and even larger up to 1 μm.

In an example of the present catalyst complex the magnetic particles have an average diameter of 2 nm-500 nm, preferably from 3 nm-100 nm, more preferably from 4 nm-50 nm, such as from 5-10 nm. It has been found that e.g., in terms of yield and recovery of catalyst complex a rather small size of particles of 5-10 nm is optimal. It is noted that the term “size” relates to an average diameter of the particles, wherein an actual diameter of a particle may vary somewhat due to characteristics thereof. In addition, aggregates may be formed e.g. in the solution. These aggregates typically have sizes in a range of 50-200 nm, such as 80-150 nm, e.g. around 100 nm.

Particle sizes and a distribution thereof can be measured by light scattering, for instance using a Malvern Dynamic light Scattering apparatus, such as a NS500 series. In a more laborious way, typically applied for smaller particle sizes and equally applicable to large sizes, representative electron microscopy pictures are taken, and the sizes of individual particles are measured on the picture. For an average particle size, a number average may be taken. In an approximation the average may be taken as the size with the highest number of particles or as a median size.

The present catalyst entity comprises at least two moieties. A first moiety relates to a moiety having a positive charge (cation). A second moiety relates to a moiety, typically a salt complex moiety, having a negative charge (anion). The negative and positive charges typically balance one another. It has been found that the positively and negatively charged moieties have a synergistic and enhancing effect on the degradation process of waste terephthalate polymer in terms of conversion and selectivity.

The positively charged moiety (cation) may be aromatic or aliphatic, and/or heterocyclic. The cationic moiety may be aliphatic and is preferably selected from guanidinium (carbamimidoylazanium), ammonium, phosphonium and sulphonium. A non-aromatic or aromatic heterocyclic moiety preferably comprises a heterocycle, having at least one, preferably at least two hetero atoms. The heterocycle may have 5 or 6 atoms, preferably 5 atoms. The positively charged moiety may be an aromatic moiety, which preferably stabilizes a positive charge. Typically, the cationic moiety carries a delocalized positive charge. The hetero-atom may be nitrogen N, phosphor P or sulphur S for instance. Suitable aromatic heterocycles are pyrimidines, imidazoles, piperidines, pyrrolidine, pyridine, pyrazol, oxazol, triazol, thiazol, methimazol, benzotriazol, isoquinol and viologen-type compounds (having f.i. two coupled pyridine-ring structures). Particularly preferred is an imidazole structure, which results in an imidazolium ion. Particularly suitable cationic moieties having N as hetero-atom comprise imidazolium, (5-membered ring with two N), piperidinium (6-membered ring with one N), pyrrolidinium (5-membered ring having one N), and pyridinium (6-membered ring with one N). Preferred imidazolium cationic moieties comprise butylmethylimidazolium (bmim⁺), and dialkylimidazoliums. Other suitable cationic moieties include but are not limited to triazolium (5-membered ring with 3 N), thiazolidium (5-membered ring with N and S), and (iso)quiloninium (two 6-membered rings (naphthalene) with N).

In a preferred method, the cationic moiety of the catalyst entity is selected from at least one of an imidazolium group, a piperidinium group, a pyridinium group, a pyrrolidinium group, a sulfonium group, an ammonium group, and a phosphonium group.

Said cationic moiety may have one or more substituents, which one or more substituents is preferably selected an alkyl moiety. In particular examples, said alkyl moiety has a length of C₁-C₆, such as C₂-C₄. In specific examples, said imidazolium group has two substituents R₁, R₂ attached to one of the two nitrogen atoms, respectively, said piperidinium group has two substituents R₁, R₂ attached to its nitrogen atom, said pyridinium group has two substituents R₁, R₂ wherein one of the two substituents R₁, R₂ is attached to its nitrogen atom, said pyrrolidinium group has two substituents R₁, R₂ attached to its nitrogen atom, said sulphonium group has three substituents R₁, R₂, R₃ attached to its sulphur atom, said ammonium group has four substituents R₁, R₂, R₃, R₄ attached to its nitrogen atom, and said phosphonium group has four substituents R₁, R₂, R₃, R₄ attached to its phosphor atom, respectively.

The negatively charged moiety (anion) may relate to an anionic complex, but alternatively to a simple ion, such as a halide. It may relate to a salt complex moiety, preferably a metal salt complex moiety, having a two- or three-plus charged metal ion, such as Fe³⁺, Al³⁺, Ca²⁺, Zn²⁺ and Cu²⁺, and negatively charged counter-ions, such as halogenides, e.g. Cl⁻, F⁻, and Br⁻. In an example the salt is a Fe³⁺ comprising salt complex moiety, such as an halogenide, e.g. FeCl₄⁻. Alternatively, use can be made of counter-ions without a metal salt complex, such as halides as known per se.

The linking group may comprise a bridging moiety for attaching the catalyst entity to the catalyst particle. The present catalyst entity and particle are combined by the bridging moiety by attaching the catalyst entity to the catalyst particle. The attachment typically involves a physical or chemical bonding between a combination of the bridging moiety and the catalyst entity on the one hand and the catalyst particle on the other hand. Particularly, a plurality of bridging moieties is attached or bonded to a surface area of the present catalyst particle. Suitable bridging moieties comprise a weak organic acid, silyl comprising groups, and silanol. More particularly, therefore, the bridging moiety comprises a functional group for bonding to the oxide of the particle and a second linking group for bonding to the catalyst entity. The functional group is for instance a carboxylic acid, an alcohol, a silicic acid group, or combinations thereof. Other acids such as organic sulphonic acids are not excluded. The linking group comprises for instance an end alkyl chain attached to the cationic moiety, with the alkyl chain typically between C₁ and C₆, for instance propyl and ethyl. The linking group may be attached to the cationic moieties such as the preferred imidazolium moiety. In the attached state, a BC complex then for instance comprises imidazolium having two alkyl groups, such as butylmethylimidazolium (bmim+) or ethylmethylimidazolium as an example.

The bridging moiety is suitably provided as a reactant, in which the linking group is functionalized for chemical reaction with the catalyst entity. For instance, a suitable functionalization of the linking group is the provision as a substituted alkyl halide. Suitable reactants for instance include 3-chloropropyltrialkoxysilane and 3-bromopropyltrialkoxysilane. The alkoxy-group is preferably ethoxy, although methoxy or propoxy groups are not excluded. It is preferred to use trialkoxysilanes, although dialkyldialkoxysilanes and trialkyl-monoalkoxysilanes are not excluded. In the latter cases, the alkyl groups are preferably lower alkyl, such as C₁-C₄ alkyl. At least one of the alkyl groups is then functionalized, for instance with a halide, as specified above.

The said reactant is then reacted with the catalyst entity. Preferably, this reaction generates the positive charge on the cationic moiety, more particularly on a hetero-atom but mostly delocalized, in the, preferably heterocyclic, cationic moiety. The reaction is for instance a reaction of a (substituted) alkyl halide with a hetero-atom, such as nitrogen, containing cationic moiety, resulting in a bond between the hetero-atom and the alkyl-group. The hetero-atom is therewith charged positively, and the halide negatively. The negatively charged halide may thereafter be strengthened by addition of a Lewis acid to form a metal salt complex. One example is the conversion of chloride to FeCl₄⁻.

According to the present invention, the bridging moiety and the catalyst entity bonded thereto are provided in an amount of (mole bridging moiety/gr magnetic particle) 5*10⁻⁶-0.1, preferably 1*10⁻⁵-0.01, more preferably 2*10⁻⁵-10⁻³, such as 4*10⁻⁵-10⁻⁴. It is preferred to have a relatively large amount available in terms of an effective optional recovery of the catalyst complex, whereas, in terms of amount of catalyst and costs thereof, a somewhat smaller amount may be preferred even more.

Notably, homogeneous catalysts are more difficult to recover from the product stream. It may even be impossible to recover such catalysts. However, it could for instance be possible to recover them prior to crystallisation of the BHET monomer, but this would require specific measures to overcome issues. The use of heterogeneous catalysts in embodiments of the invented method is therefore preferred.

The catalyst may in preferred embodiments be used in a ratio of 0.001-20 wt. %, more preferably 0.01-10 wt. %, and most preferably 0.01-5 wt. %, relative to the polymer weight.

The present invention provides an efficient method of recovering polyurethane, and optionally other polymers such as polyamides and acrylic polymers, from a waste textile material that comprises polyester, such as PET. The method is relatively robust, substantially insensitive to the presence of additives and impurities, and preferably makes use of a limited number of solvents. As such the present method is especially suited for waste textile material streams, such as from clothing or carpets. Moreover, the remaining polyester is ready for further processing and particularly depolymerization because remaining substances such as polymer, degraded polymer and solvents are effectively removed before such further processing.

The present invention may in embodiments also provide a BHET monomer after depolymerization with a relatively high purity. A high purity in the context of the present invention may mean a relatively low amount of polar aprotic solvent, for instance DMAc, and/or a relatively low amount of polyurethane polymer present in the BHET monomer after pre-treatment and depolymerization. The amount of polar aprotic solvent and polyurethane polymer in the BHET may conveniently be measured by total nitrogen content. According to the invention, a BHET product may be obtained by embodiments of the invented method having a total nitrogen content below 1000 ppm, more preferably below 800 ppm, even more preferably below 500 ppm, and most preferably below 300 ppm. Other obtainable BHET products have a total nitrogen content below 150 ppm, preferably below 100 ppm, more preferably below 30 ppm, even more preferably below 15 ppm, and yet more preferably below 10 ppm. In other embodiments of the method, a BHET product may be obtained having a total nitrogen content above 0.06 ppm, preferably above 0.07 ppm, more preferably above 0.08 ppm, and even preferably above 0.09 ppm. The above embodiments may be combined in total nitrogen content ranges, for instance a total nitrogen content between 0.06 and 1000 ppm, preferably between 0.07 and 800 ppm, even more preferably between 0.08 and 500 ppm, and most preferably between 0.09 and 300 ppm.

Another measure of the purity of the obtained BHET monomer after depolymerization relates to its color, for instance as shown in the well-known CIELAB color space, which covers the entire range of human color perception. A lightness value, L*, defines black at 0 and white at 100. An a* axis is relative to the green-red opponent colors, with negative values toward green and positive values toward red. A b* axis finally represents the blue-yellow opponents, with negative numbers toward blue and positive toward yellow. It has been found by the inventors that the b* in particular is relevant to characterize the color of the obtained BHET monomer, since yellowing appears to be predominant. Indeed, b* appears to be a good indicator for the presence of residual products of both elastane (degradation to polyol and colored dicarbamates, the glycol ester of the isocyanate) and optionally also PAN.

It turned out that a BHET product could be obtained by embodiments of the method having a b*-value of below 2, such as below 1.5, below 1.0, or below 0.5. The b*-value of a BHET product obtainable by embodiments of the invented method is above 0, such as above 0.05, or above 0.1. If b* is below 0, the BHET product would be too blue. The above embodiments may be combined in ranges of b*-values.

In embodiments, the wording ‘A BHET product, obtainable by a method as claimed herein’ can be replaced with ‘A BHET product, obtained by a method as claimed herein’.

The invention is further detailed by the examples, which are exemplary and explanatory of nature and are not limiting the scope of the invention. To the person skilled in the art, it may be clear that many variants, being obvious or not, may be conceivable falling within the scope of protection, defined by the appended claims. In the accompanying figures,

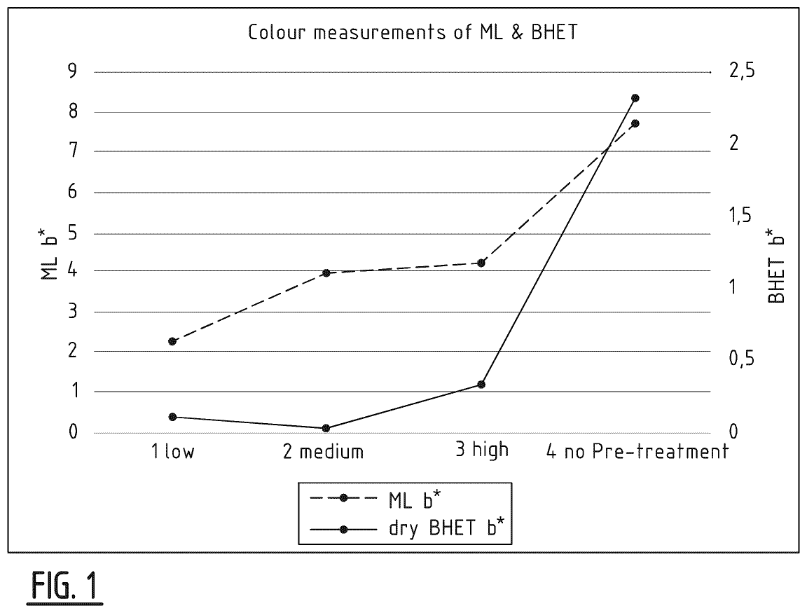

FIG. 1 schematically shows color measurements of mother liquor (ML) and BHET obtained for Examples 3-1 to 3-3 according to embodiments of the invention and Comparative Experiment A;

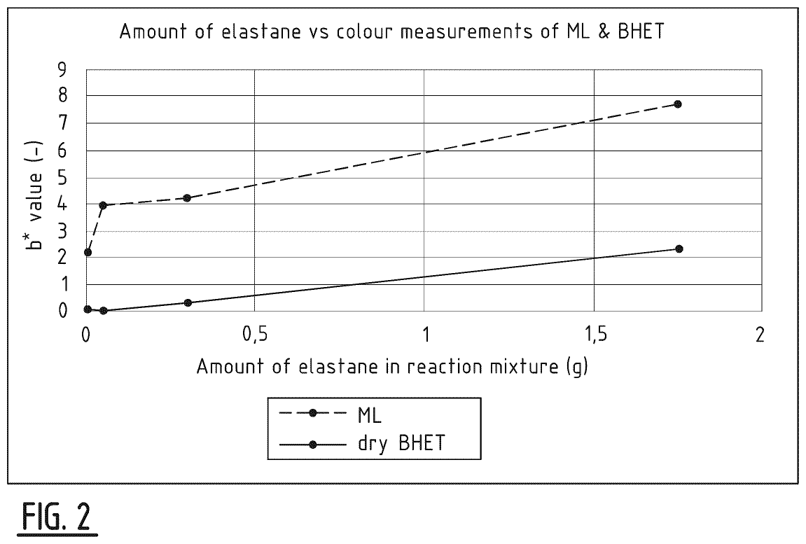

FIG. 2 schematically shows the correlation between the measured color measurements of FIG. 1 and the amount of Elastane remaining in the ML and dried BHET obtained for Examples 3-1 to 3-3 according to embodiments of the invention and Comparative Experiment A;

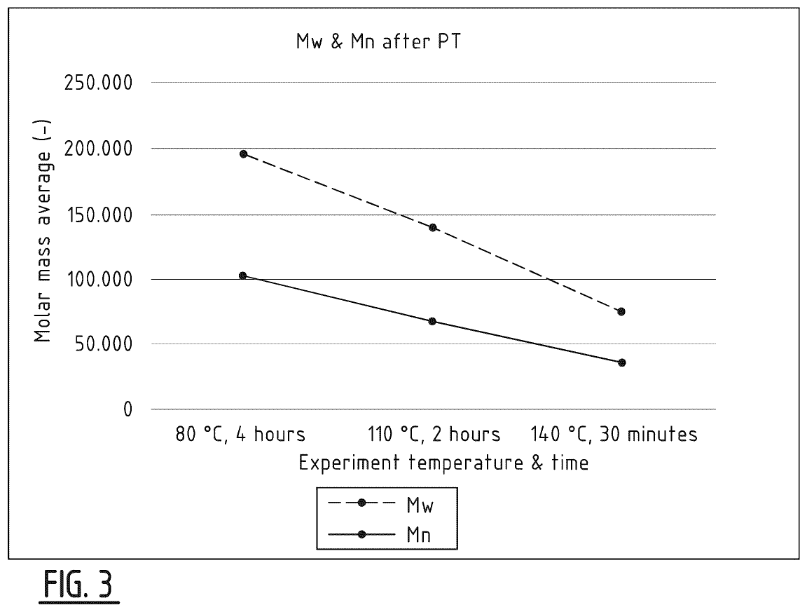

FIG. 3 schematically shows the average molecular weights (Mw and Mn) of precipitated and extracted Elastane obtained according to embodiments of the invention and to Comparative Experiment B;

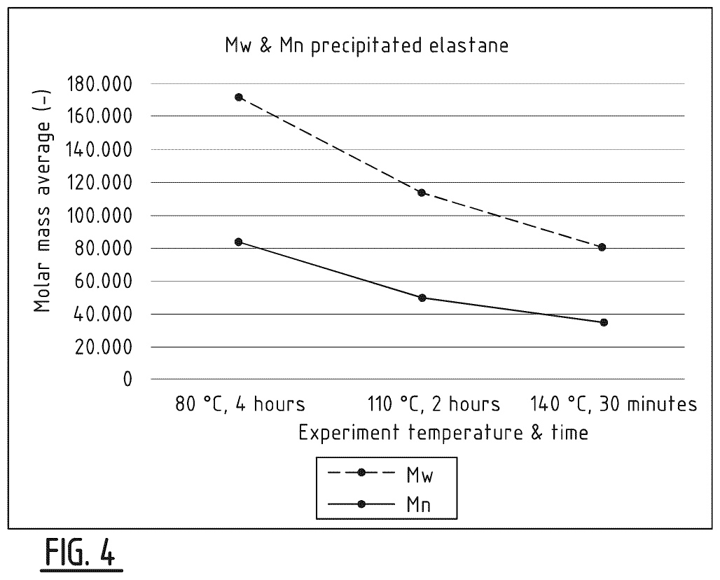

FIG. 4 schematically shows the average molecular weights (Mw and Mn) of precipitated and extracted Elastane obtained according to other embodiments of the invention and to Comparative Experiment B; and

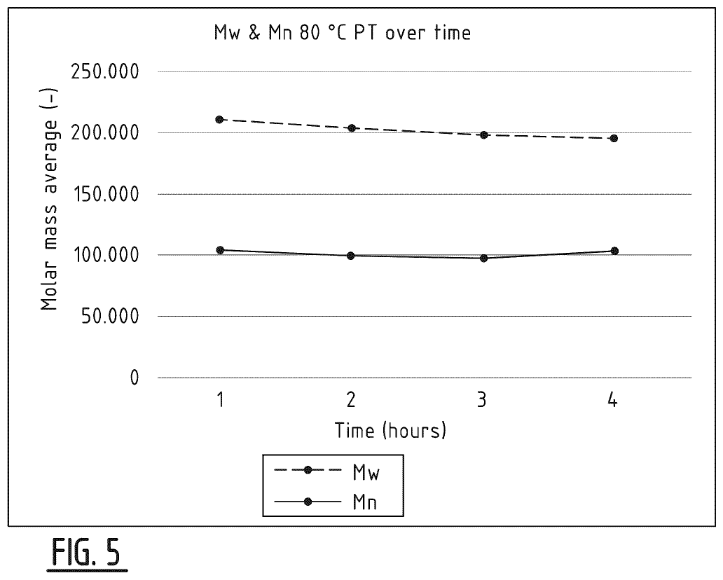

FIG. 5 finally shows the variation observed in Mw and Mn over time after pre-treatments performed at 80 °C for 4 hours according to an embodiment of the invention.

### EXAMPLES

### Initial Waste Material

Textile waste material was obtained that contained about 95 wt. % PET and 5 wt. % Elastane fibers. Other materials contained nylon fibers and/or polyacrylonitrile (PAN)-fibers in addition to the Elastane fibers. The fibers were interwoven but it is also possible for the fibers of different type to be co-mingled. The PET fibers provide the most important properties of the textile fabric while the other fibers provide other properties, such as the Elastane fibers providing elasticity. When recycled, the waste textile material is typically shredded in a mechanical recycler that may then be fiberized to produce a fluff out of it. Alternatively, pieces of cut material of the waste textile material may be produced. Shredded material provided by sorters in big bags does not facilitate separation of the different fibers as the typical dimensions of shredded material are too large. Cutting the waste material into smaller pieces therefore is preferred.

One of the objectives of the present invention is to obtain polyurethane polymer such that it can be re-used directly without having to polymerize it again or having to purify it.

### Additional Materials Used

N,N-dimethylacetamide (DMAc, anhydrous, 99.8%) as polar aprotic solvent was obtained from Sigma-Aldrich. Ethylene glycol (EG) as alcoholic solvent was obtained from Sigma-Aldrich. A catalyst was not used when dissolving the polyurethane in the polar aprotic solvent.

### Analysis of Nitrogen Content

Extracted polyester was analyzed for Nitrogen content according to ASTM D6069 and ASTM D4629 using a Trace Elemental Instruments XPLORER TN/TS analyzer. Non extracted waste fabric was analyzed for Nitrogen content as well and the determined value was assumed to correspond to the 5 wt. % of Elastane in the waste fabric. The nitrogen content was determined according to the above-referred chemiluminescence methods, with a flow of ozone, after oxidative combustion of a sample at a temperature of ~1000 °C and in the presence of an oxidizing mixture composed of oxygen and of argon and compared to a calibration series

### Analysis of Molecular Weight of Extracted Polyurethane

Gel permeation chromatography (GPC) was performed on a Viscotek GPC Max & TDA302 system. GPC columns 2*30 cm Polargel M were used. Data were calculated with OmniSEC™, Version 4. software. Dimethylformamide (DMF) containing 0.02 m lithium bromide was used as eluent with a flow-rate of 0.8 ml/min. About 200 mg of extracted Elastane at an accuracy of 0.01 g was dissolved in 10.0 ml eluent. Linear PMMA standards ex Agilent (set PMMA7) was used to calibrate the setup.

Separation of Polyurethane from PET/Polyurethane Textile Waste Material

### Example 1: Extraction at 80 °C for 4 Hours and Addition of Boiling Water

Polyester/Elastane (95/5 wt. %) waste material was cut to pieces of more or less rectangular shape and measuring about 2×2 to 5×5 cm. Total nitrogen content of the waste material was 1020 ppm. An amount of fabric pieces in the range of 10 g on dry matter basis was weighed and put in a round bottom flask of 250 ml, together with 140 ml of DMAc solvent. The mixture was heated using an Ika C-MAG HS 7 hotplate with oil bath to 80 °C and kept at that temperature for 4 hours under continuous mechanical stirring to disintegrate the polyurethane fibers and to dissolve the polyurethane and extraction via solid-liquid extraction. After the extraction was completed, the remaining PET was filtered over a crude filter to remove the DMAc and dissolved polyurethane fibers via solid-liquid separation. In order to enhance polyurethane precipitation in the DMAc, boiling water was added in a 1 to 1 weight ratio compared to the initial amount of DMAc and stirred. As a result of this, the polyurethane would precipitate immediately and would form a chunk of elastic material that would float. The degree of precipitation of polyurethane from the DMAc solvent could be observed as turbidity of the mixture [after 15 minutes]. The resulting polyurethane, precipitated in a 1 to 1 weight % DMAc/water solution, was filtered over a Buchner filter under reduced pressure equipped with a paper filter with a 12-15 μm pore size. The majority of the polyurethane precipitate was recovered from the paper filter, while fine polyurethane precipitate had passed the paper filter yielding a turbid filtrate.

The number average molecular weight Mn of the recovered polyurethane was determined to be 83000 Da. The weight average molecular weight Mw of the recovered polyurethane was 171000 Da. These relatively high molecular weights yielded an improved precipitation of the polyurethane from the DMAc solvent.

### Assessment of Extraction Efficiency

The polyester fabric was then washed with 25 ml of DMAc and subsequently with 25 ml of ethylene glycol (EG) and filtered over the same filter again under reduced pressure. The washing procedure was repeated once again, prior to washing 5 times with excess (about 150 ml) demi water. The extracted fabric was dried in a vacuum oven at 60 °C and the dry weight was determined. The remaining amount of total nitrogen in the PET fabric was 105 ppm resulting in an extraction efficiency of approximately 90% compared to the starting material. It should be noted that leftover DMAc could partially account for total nitrogen content and that the 1020 ppm starting value may have been higher since it was outside the calibration range of the total nitrogen analyzer. The precipitated and collected polyurethane was also measured for total nitrogen content which resulted in 2600 ppm total organic nitrogen which again was outside the calibration range.

### Example 2: Extraction at 80 °C for 4 Hours and Addition of Cold Water to Enhance Precipitation

Example 1 was repeated but in order to further enhance polyurethane precipitation in the DMAc, cold water at a temperature of 40 °C was added in a 1 to 1 weight ratio compared to the initial amount of DMAc and stirred. As a result of this, more of the polyurethane would precipitate immediately and would form a chunk of elastic material that would float. Indeed, more polyurethane precipitate was recovered from the paper filter than in Example 1.

### Example 3-1: Extraction at 80 °C for 4 Hours and Subsequent Treatment with Ethylene Glycol (EG)

Polyester/Elastane (95/5 wt. %) waste material was cut to pieces of more or less rectangular shape and measuring about 2×2 to 5×5 cm. An amount of fabric pieces in the range of 10 g on dry matter basis was weighed and put in a round bottom flask of 250 ml, together with 140 ml of DMAc solvent. The mixture was heated using an Ika C-MAG HS 7 hotplate with oil bath to 80 °C and kept at that temperature for 4 hours under continuous mechanical stirring to disintegrate the polyurethane fibers and to dissolve the polyurethane via solid-liquid extraction. After the extraction was completed, the remaining PET was filtered over a crude filter and compressed to remove the DMAc and dissolved polyurethane fibers via solid-liquid separation. In order to enhance polyurethane precipitation in the DMAc, boiling water was added in a 1 to 1 weight ratio compared to the initial amount of DMAc and stirred. As a result of this, the polyurethane would precipitate immediately and would form a chunk of elastic material that would float. The resulting polyurethane, precipitated in a 1 to 1 weight % DMAc/water solution, was filtered over a Buchner filter under reduced pressure equipped with a paper filter with a 12-15 μm pore size. The majority of the polyurethane precipitate was recovered from the paper filter, while fine polyurethane precipitate had passed the paper filter yielding a turbid filtrate.

Once as much of the DMAc was removed, alcoholic solvent (EG) was added to the textile at a weight ratio of 1:20. The EG was then heated to 150 °C for 15 minutes to remove dyes and leftover DMAc and Elastane from the textile. The textile was then compressed again over a crude filter so that most of the EG and leftover DMAc was removed from the textile.

The above procedure resulted in about 1 g DMAc and about 0.005 g Elastane in the reaction mixture containing the polyester fabric. The reaction mixture weight was 320 g, and the Elastane in the reaction mixture amounted to 0.0015 wt. %.

The ensuing polyester fabric pieces were then depolymerized at 197 °C for about 1 to 2 hrs and the ensuing BHET monomer was recovered from the reaction mixture by precipitation and crystallization.

### Example 3-2: Extraction at 80 °C for 4 Hours and Subsequent Treatment with Ethylene Glycol (EG)

The procedure described under Example 3-1 was repeated except that the washed polyester fabric was not compressed or squeezed (both DMAc and EG treatment). This procedure resulted in about 10 g DMAc and about 0.05 g Elastane in the reaction mixture containing the polyester fabric. The reaction mixture weight was 288 g, and the Elastane in the reaction mixture amounted to 0.017 wt. %.

BHET was obtained as described above for Example 3-1.

### Example 3-3: Extraction at 80 °C for 4 Hours and No Subsequent Treatment with Ethylene Glycol (EG)

The procedure described under Example 3-1 was repeated except that the polyester fabric was not washed with ethylene glycol (EG) at all. This procedure resulted in about 61 g DMAc and about 0.3 g Elastane in the reaction mixture containing the polyester fabric. The reaction mixture weight was 349 g, and the Elastane in the reaction mixture amounted to 0.085 wt. %.

BHET was obtained as described above for Example 3-1.

### Comparative Experiment A: No Extraction at 80 °C for 4 Hours and No Subsequent Treatment with Ethylene Glycol (EG)

The polyester waste fabric of Example 3-1 was not pre-treated at all and used as such. This resulted in 0 g DMAc and about 1.5-2 g Elastane in the reaction mixture containing the polyester fabric. The reaction mixture weight was 280 g, and the Elastane in the reaction mixture amounted to 0.5-0.7 wt. %.

BHET was obtained as described above for Example 3-1.

The color of the mother liquor and BHET was measured according to well-known practices in terms of a b*-value, which is a measure of yellowness. The b*-value was measured on the mother liquor (ML) and on the dry BHET, obtained from the mother liquor by separation (Dry BHET). The results of Examples 3-1 to 3-3 (referred to in FIG. 1 as low, medium, and high) and of Comparative Experiment A are shown in FIG. 1 in terms of color measurements of the mother liquor (ML) and dried BHET. FIG. 2 shows the correlation between the b*-value and the amount of Elastane for these Examples 3-1- to 3-3 and Comparative Experiment A. From these FIGS. 1 and 2, it can be concluded that the amount of Elastane remaining in the polyester fabric is largely responsible for any yellowing that occurs in the obtained BHET after depolymerization. It further shows that pre-treatment with EG is important in that it reduces yellowing. This may be due to evaporation of DMAc in this process before actual depolymerization, although other explanations are not excluded.

To confirm evaporation of DMAc, a mixture of DMAc and EG (1:1 wt. %) was heated in a closed vessel to prevent evaporation. It indeed shows that yellowing occurs in the mixture and, when DMAc is distilled off, the yellow color remains in the EG.

### Example 4: Extraction at 80 °C for 4 Hours and Addition of Cold Water in Different Amounts

The procedure of Example 1 was repeated except that the amount of water was selected such that the DMAc/water weight ratio was varied between 90/10 and 50/50. It turned out that the degree of precipitation of polyurethane from the DMAc solvent, observed as an amount of precipitated fraction after 15 minutes, decreased with decreasing water content for DMAc/water ratios of 50/50, 80/20, 66/33 and 90/10 respectively. It should be noted that higher starting concentrations of polyurethane in the waste fabric may need less water or no water to precipitate.

### Examples 5-6 and Comparative Experiment B: Extraction at Different Temperatures and Times and Addition of Cold Water to Enhance Precipitation

### Example 5

Example 1 was repeated except that the mixture was heated using an Ika C-MAG HS 7 hotplate with oil bath to 110 °C and kept at that temperature for 2 hours under continuous mechanical stirring to disintegrate the polyurethane fibers and to dissolve the polyurethane and extract it via solid-liquid extraction.

### Comparative Experiment B

Example 1 was repeated except that the mixture was heated using an Ika C-MAG HS 7 hotplate with oil bath to 140 °C and kept at that temperature for 30 min under continuous mechanical stirring to disintegrate the polyurethane fibers and to dissolve the polyurethane and extract it via solid-liquid extraction. The mixture was cooled down to 80 °C and boiling water was added after the cooling down. Precipitation of the polyurethane turned out to be substantially slower than in Example 1.

### Example 6

Example 1 was repeated except that the mixture was heated using an Ika C-MAG HS 7 hotplate with oil bath to 80 °C and kept at that temperature for 1 hour under continuous mechanical stirring to disintegrate the polyurethane fibers and to dissolve the polyurethane and extract it via solid-liquid extraction.

### Example 7

Example 1 was repeated except that the mixture was heated using an Ika C-MAG HS 7 hotplate with oil bath to 80 °C and kept at that temperature for 2 hours under continuous mechanical stirring to disintegrate the polyurethane fibers and to dissolve the polyurethane and extract it via solid-liquid extraction.

### Example 8

Example 1 was repeated except that the mixture was heated using an Ika C-MAG HS 7 hotplate with oil bath to 80 °C and kept at that temperature for 3 hours under continuous mechanical stirring to disintegrate the polyurethane fibers and to dissolve the polyurethane via solid-liquid extraction.

The results of the Examples 5-8 and Comparative Experiment B are shown in FIGS. 3 to 5 and in Table 1 below.

FIG. 3 shows one of the most important findings, i.e that the Elastane chains become shorter when the temperature of the pre-treatment is increased even though a shorter pre-treatment time is used. The results show that the pre-treatment with DMAc at 80 °C for 4 hours results in the longest Elastane chains, while still removing substantially all of the Elastane from the textile. These longer Elastane chains are thought to be needed for better precipitation. Also, the longer Elastane chains are more valuable from the perspective of recycling the Elastane.

FIG. 4 shows that the precipitated and extracted Elastane has a slightly lower Mw and Mn compared to the samples that were pre-treated. This may be due to less homogenous solid samples. It also turned out that very little Elastane could be obtained from the experiments at 140 °C (Comparative Experiment B). Indeed, the filters tended to clog, and the DMAc could not be removed to a substantially full extent.

FIG. 5 finally shows the kinetic samples of pre-treatments performed at 80 °C for 4 hours. Interestingly, these experiments do not show a substantial change in Mw and Mn over time while we have seen a decreasing Mw and Mn over time in the other experiments. It seems that degradation of the Elastane chains does not occur but that 80 °C is high enough to at least dissolve and extract the Elastane from the textile. FIG. 5 also indicates that shorter pre-treatment times that 4 hours at 80 °C may be possible. These results also indicate that performing the DMAc pre-treatment at 80 °C does not degrade the Elastane too much so it can be more easily recycled.

TABLE 1
measured molecular weights of polyurethane

| Experiment | | Sample | Mw | Mn | Mw/Mn | Mz | Example |
|---|---|---|---|---|---|---|---|
| 1-80 | °C | 1 | 195.000 | 102.000 | 1.9 | 334.000 | Example 1 |
| 2-110 | °C | 2 | 139.000 | 67.000 | 2.1 | 123.000 | Example 5 |
| 3-140 | °C | 3 | 74.000 | 35.000 | 2.1 | 123.000 | Comparative |
| | | | | | | | experiment B |
| 1-80 | °C | 4 | 210.000 | 103.000 | 2.0 | 372.000 | Example 6 |
| 1-80 | °C | 5 | 203.000 | 99.000 | 2.1 | 355.000 | Example 7 |
| 1-80 | °C | 6 | 198.000 | 97.000 | 2.0 | 333.000 | Example 8 |
| 1-80 | °C | 7 | 171.000 | 83.000 | 2.1 | 261.000 | Example 1 |
| 2-110 | °C | 8 | 113.000 | 49.000 | 2.3 | 181.000 | Example 5 |
| 3-140 | °C | 9 | 80.000 | 34.000 | 2.3 | 134.000 | Comparative |

experiment B

### Example 9

This example shows the beneficial effect of cutting the feedstock (the waste polymer textile material) instead of shredding the feedstock in pieces having about the same size.

Example 1 was repeated in that that to 200 gram of the textile material was added to 4000 ml of DMAc (a textile to solvent ratio of 1:20). The mixture was pre-treated for 4 hrs. at 80 °C. Then the dissolved Elastane and DMAc were separated from the PET by using a crude filter. In another step, the same 4000 ml of DMAc were used as solvent for the next 200 gram of the textile material (bringing the effective textile to solvent ratio to 1:10). Due to the higher volume of fiberized textile material compared to cut textile material, it turned out that not all of the fiberized textile material could be brought into the given amount of DMAc solvent, because all solvent was absorbed by the fiberized textile. The extraction of polyurethane therefore was not optimal. In contrast herewith, the cut textile material was completely submerged into the DMAc solvent in the amounts given. This improved the polyurethane extraction.

A preferred method according to the invention therefore comprises the following steps. Cut the textile in pieces (for instance 2×2 to 5×5 cm). Add the cut textile to a container, such as a beaker or RBF. Add the polar aprotic solvent such as DMAc in an amount to reach a textile to solvent ratio of 20. Increase the temperature of the mixture to 80 °C and let is stir for about 4 hours. While the mixture is still hot, filter the textile and solvent over a crude filter. Press or squeeze the textile so that as much of the leftover DMAc is removed from the textile and collect the solvent. The solvent is then used again for another textile pre-treatment, resulting in an effective textile to solvent ratio of 1 to 10. Optionally wash the textile with water before pre-treatment with an alcoholic solvent such as EG. Once as much of the DMAc is removed, again add the textile to the alcoholic solvent, for instance EG, at a ratio of 1:20.

Now heat the EG to 150 °C for 15 minutes and pre-treat the textile to remove dyes and leftover DMAc. The temperature of EG should not be too high in order to prevent at least partly or substantially degrading the DMAc. Again, filter the textile over a crude filter and press or squeeze the textile so that most of the EG and leftover DMAc is removed. The textile is now ready to be depolymerized. The EG used for the pre-treatment can again be used for the same pre-treatment so that again a textile to solvent ratio of 1:10 is reached.

To obtain the Elastane, let the solution cool down and add cold water (1 to 1) to the DMAc and let the Elastane precipitate for 15 minutes. After the precipitation is complete, filter the material over a 12-15 μm filter and wash the residual Elastane with water or ethanol/acetone.

### Comparative Experiment C

Example 1 was repeated except that the mixture was heated using an Ika C-MAG HS 7 hotplate with oil bath to 160-165 °C and kept at that temperature for 10 min under continuous mechanical stirring to disintegrate the polyurethane fibers and to dissolve the polyurethane via solid-liquid extraction. It turned out that part of the polyester fibers also started to dissolve at these temperatures, forming a slurry and negatively affecting polyurethane extraction. Obviously, losing some polyester during pre-treatment is less desirable.

### Comparative Experiment D

Example 1 was repeated except that the mixture was heated using an Ika C-MAG HS 7 hotplate with oil bath to 140 °C and kept at that temperature for 30 min under continuous mechanical stirring to disintegrate the polyurethane fibers and to dissolve the polyurethane via solid-liquid extraction. The mixture was cooled down to 80 °C and cold water was added after the cooling down. Precipitation of the polyurethane turned out to be comparably slow in Comparative Experiment D and therefore substantially slower than in Example 1.

### Example 10

Example 1 was repeated using polyacrylonitrile (PAN) fiber textile material with some differences as described below. The mixture of textile material and DMAc was heated using an Ika C-MAG HS 7 hotplate with oil bath to 50 °C and kept at that temperature for 4 hours under continuous mechanical stirring to disintegrate the PAN fibers and to dissolve the PAN via solid-liquid extraction. After the extraction was completed, the remaining PET was filtered over a crude filter to remove the DMAc and dissolved PAN fibers via solid-liquid separation.

It turned out that the PAN was easily removed from the mixture during pre-treatment with DMAc at 50 °C. PAN was substantially removed from the polyester fabric after washing with 25 ml of ethylene glycol (EG) and filtering under reduced pressure. The washing procedure was repeated once again, prior to washing 5 times with excess (about 150 ml) demi water.

1. A method of recovering polyurethane polymer from a waste polymer textile material that comprises polyester and polyurethane fibers, the method comprising the steps of:
a) providing the waste polymer textile material in shredded or cut form;
b) contacting the waste polymer textile material in shredded or cut form with a polar aprotic solvent at a temperature from 25 °C to 125 °C to dissolve the polyurethane at least partly in the polar aprotic solvent while the polyester remains substantially unaffected;
c) separating the polyester from the solvent mixture comprising the polar aprotic solvent and the polyurethane dissolved therein by solid-liquid separation;
d) precipitating the dissolved polyurethane in the solvent mixture;
e) separating the precipitated polyurethane from the solvent mixture to obtain polyurethane polymer and used polar aprotic solvent; and
f) optionally reusing the used polar aprotic solvent at least partly in step b).

2. The method as claimed in claim 1, wherein precipitating the dissolved polyurethane in the solvent mixture in step d) comprises adding water to the solvent mixture, wherein the solvent mixture is optionally cooled to a temperature below the contacting temperature of step b) before, during or after adding the water.

3. The method as claimed in claim 2, wherein the water added has a temperature from 1 °C-100 °C at ambient pressure, more preferably from 5 °C-50 °C at ambient pressure, even more preferably from 10 °C-40 °C, and most preferably from 15 °C-30 °C at ambient pressure.

4. The method as claimed in claim 1, wherein the polyurethane polymer obtained in step e) has a Mn of at least 50000 Da.

5. The method as claimed in claim 2, wherein the added water is separated from the used polar aprotic solvent obtained in step e) before the optional reuse of the polar aprotic solvent according to step f).

6. The method as claimed in claim 1, wherein the polyester obtained in step c) is squeezed and/or washed to further remove polar aprotic solvent that is still present in the polyester, wherein the optional washing is preferably carried out in countercurrent flow.

7. The method as claimed in claim 1, further comprising the step of:
a) contacting the polyester obtained in step c) with a polyol solvent at a temperature from 50 °C to 200 °C to further dissolve potentially remaining polyurethane in the polyol solvent and evaporate the polar aprotic solvent while the polyester remains substantially unaffected; and
b) separating the polyester from the polyol solvent mixture comprising the polyol solvent, the potentially remaining polyurethane dissolved therein and potentially remaining polar aprotic solvent, by solid-liquid separation.

8. The method as claimed in claim 7, wherein an amount of polar aprotic solvent that is still present in the polyester after step h) relative to an amount of alcoholic solvent is below 1:1.

9. The method as claimed in claim 7, wherein the waste polymer textile material further comprises polyamide fibers and the polyamide is dissolved in step g) and then separated from the polyester in step h).

10. The method as claimed in claim 1, wherein the waste polymer textile material further comprises acrylic polymer fibers, the acrylic polymer is dissolved in step b), and the dissolved acrylic polymer is separated from the first mixture in step d).

11. The method as claimed in claim 1, wherein the waste polymer textile material further contains functional additives such as dyes, and the functional additives are dissolved in the polar aprotic solvent and separated from the polyester in step d) with the polar aprotic solvent.

12. The method as claimed in claim 1, wherein the polar aprotic solvent comprises dimethylacetamide.

13. The method as claimed in claim 7, wherein the polyol solvent comprises a glycol, more preferably an alkylene glycol, selected from ethylene glycol (1,2-ethane diol), propylene glycol (1,3-propane diol), 1,4-butane diol and 1,5-pentane diol.

14. The method as claimed in claim 1, wherein step b) is carried out a temperature from 60 °C to 100 °C.

15. The method as claimed in claim 7, wherein step g) is carried out a temperature from 110 °C to 190 °C, more preferably from 120 °C to 170 °C, even more preferably from 130 °C to 150 °C.

16. The method as claimed in claim 1, wherein a weight ratio of polar aprotic solvent to textile waste material ranges from 1:2 to 1:40.

17. The method as claimed in claim 1, wherein the polyester comprises polyethylene terephthalate.

18. The method as claimed in claim 1, wherein the polyurethane comprises a polyether-polyurea copolymer.

19. The method as claimed in claim 10, wherein the acrylic polymer comprises polyacrylonitrile.

20. The method as claimed in claim 1, wherein the waste polymer material comprises from 85-99 wt. % polyester, from 1-15 wt. % polyurethane, and optionally polyamide and/or acrylic polymer, the total adding up to 100 wt. %.

21. The method as claimed in claim 1, wherein step b) is carried out during from 0.5 h to 8 h, more preferably from 2 h to 6 h.

22. The method as claimed in claim 7, wherein step g) is carried out during from 5 min to 60 min, more preferably from 10 min to 40 min.

23. The method as claimed in claim 1, further comprising the steps of:
c) adding a reactive solvent to disperse the polyester recovered after step h) and obtain a dispersion;
d) adding a depolymerization catalyst to the dispersion; and
e) depolymerizing the polyester under conditions to obtain monomers and/or oligomers dissolved in the reactive solvent,
wherein the reactive solvent comprises a polyol, optionally the polyol obtained from step h).

24. The method as claimed in claim 23, wherein the depolymerization is carried out at a temperature of at least 160 °C, preferably of at least 180 °C, more preferably of at least 190 °C, and even more preferably of at most 250 °C.

25. The method as claimed in claim 23, wherein the catalyst for depolymerizing the polyester comprises a functionalized magnetic particle that is functionalized with a catalytic moiety.

26. A BHET product obtainable or obtained by the method as claimed in claim 23 and having a total nitrogen content below 1000 ppm, preferably below 800 ppm, even more preferably below 500 ppm, and most preferably below 300 ppm.

27. The BHET product as claimed in claim 26, having a total nitrogen content above 0.06 ppm, preferably above 0.07 ppm, more preferably above 0.08 ppm, and even more preferably above 0.09 ppm.

28. The BHET product as claimed in claim 26, having a b*-value corresponding to CIELAB color space of below 2, such as below 1.5, below 1.0, or below 0.5.

29. The BHET product as claimed in claim 26, having a b*-value corresponding to CIELAB color space of above 0, such as above 0.05, or above 0.1.
